(19) United States
(12) Patent Application Publication
(10) Pub. No.: US 2003/0046212 A1
(43) Pub. Date: Mar. 6, 2003

(54) Resource allocation techniques

(76) Inventors: Brian A. Hunter, Boston, MA (US); Soulaymane Kachani, Cambridge, MA (US)

Correspondence Address: GORDON E NELSON, PATENT ATTORNEY, PC, 57 CENTRAL ST, PO BOX 782, ROWLEY, MA, 01969, US

(21) Appl. No.: 10/018,696

(22) PCT Filed: Jan. 9, 2001
(86) PCT No.: PCT/US01/00636

(51) Int. Cl. G06F 17/60

(52) U.S. Cl. 705/36

(57) ABSTRACT

Resource allocation techniques for determining an allocation of investment funds among a set of at least two asset classes for a period of time which maximizes return on the investment funds over the period of time. In one aspect of the techniques, the return on the investment funds is determined using real options. In another aspect of the techniques, reliability of return is used to quantify the effects of the diversification resulting from the use of different classes of assets (203). The reliability of return is then used as a constraint on the maximization of the return. The reliability of return is determined (205) by establishing correlations between the asset classes with regard to risk, using the correlations with the standard deviations for the asset classes to determine covariances between the asset classes, and using the covariances to determine the standard deviation for the risk for the entire set. The standard deviation is then used together with the return to determine the reliability of the return (211).

### CROSS REFERENCES TO RELATED APPLICATIONS

The present patent application claims priority from U.S. provisional application No. 60/175,261, Hunter, et al., Resource allocation techniques, filed Jan. 10, 2000.

### BACKGROUND OF THE INVENTION

1. Field of the Invention

The invention concerns techniques for allocating a resource among a number of potential uses for the resource such that a satisfactory tradeoff between a risk and a return on the resource is obtained. More particularly, the invention concerns improved techniques for determining the risk-return tradeoff for particular uses, techniques for determining the contribution of uncertainty to the value of the resource, techniques for specifying risks, and techniques for quantifying the effects and contribution of diversification of risks on the risk-return tradeoff and valuation for a given allocation of the resource among the uses.

2. Description of Related Art

People are constantly allocating resources among a number of potential uses. At one end of the spectrum of resource allocation is the gardener who is figuring out how to spend his or her two hours of gardening time this weekend; at the other end is the money manager who is figuring out how to allocate the money that has been entrusted to him or her among a number of classes of assets. An important element in resource allocation decisions is the tradeoff between return and risk. Generally, the higher the return the greater the risk, but the ratio between return and risk is different for each of the potential uses. Moreover, the form taken by the risk may be different for each of the potential uses. When this is the case, risk may be reduced by diversifying the resource allocation among the uses.

Resource allocation thus typically involves three steps:

1. Selecting a set of uses with different kinds of risks;

2. determining for each of the uses the risk/return tradeoff; and

3. allocating the resource among the uses so as to maximize the return while minimizing the overall risk.

As is evident from proverbs like “Don't put all of your eggs in one basket” and “Don't count your chickens before they're hatched”, people have long been using the kind of analysis summarized in the above three steps to decide how to allocate resources. What is relatively new is the use of mathematical models in analyzing the risk/return tradeoff. One of the earliest models for analyzing risk/return is net present value; in the last ten years, people have begun using the real option model; both of these models are described in Timothy A. Luehrman, “Investment Opportunities as Real Options: Getting Started on the Numbers”, in: Harvard Business Review, July-August 1998, pp. 3-15. The seminal work on modeling portfolio selection is that of Harry M. Markowitz, described in Harry M. Markowitz, Efficient Diversification of Investments, second edition, Blackwell Pub, 1991.

The advantage of the real option model is that it takes better account of uncertainty. Both the NPV model and Markowitz's portfolio modeling techniques treat return volatility as a one-dimensional risk. However, because things are uncertain, the risk and return for an action to be taken at a future time is constantly changing. This fact in turn gives value to the right to take or refrain from taking the action at a future time. Such rights are termed options. Options have long been bought and sold in the financial markets. The reason options have value is that they reduce risk: the closer one comes to the future time, the more is known about the action's potential risks and returns. Thus, in the real option model, the potential value of a resource allocation is not simply what the allocation itself brings, but additionally, the value of being able to undertake future courses of action based on the present resource allocation. For example, when a company purchases a patent license in order to enter a new line of business, the value of the license is not just what the license could be sold to a third party for, but the value to the company of the option of being able to enter the new line of business. Even if the company never enters the new line of business, the option is valuable because the option gives the company choices it otherwise would not have had. For further discussions of real options and their uses, see Keith J. Leslie and Max P. Michaels, “The real power of real options”, in: The McKinsey Quarterly, 1997, No. 3, pp. 4-22, and Thomas E. Copland and Philip T. Keenan, “Making real options real”, The McKinsey Quarterly, 1998, No. 3, pp. 128-141.

In spite of the progress in applying mathematics to the problem of allocating a resource among a number of different uses, difficulties remain. First, the real option model has heretofore been used only to analyze individual resource allocations, and has not been used in portfolio selection. Second, there has been no good way of quantifying the effects of diversification on the overall risk. It is an object of the invention to overcome each of these problems and thereby to provide improved resource allocation techniques.

### SUMMARY OF THE INVENTION

The resource allocation techniques disclosed herein solve the first of the foregoing problems by providing a technique that uses a real option function in a linear or non-linear optimization program to determine an allocation of investment funds among a set of at least two asset classes for a period of time which will maximize the value of the set of asset classes over the period of time.

The resource allocation techniques solve the second of the foregoing problems by introducing the notion of reliability to quantify the effects of diversification. The technique determines reliability of a first factor, for example the value of a set of asset classes, which is dependent on a set of at least two second factors, for example asset classes to which the funds have been allocated, where each of the second factors is diversely subject to a third factor, for example uncertainty. The reliability may be determined by establishing correlations between the second factors with regard to the third factor, using the correlations in determining a standard deviation of the third factor for the set, and using the first factor and the standard deviation in determining the reliability of the first factor with regard to the third factor. There may be more than one of the third factors, and they may be combined in various ways.

The reliability technique may be used to provide a constraint for linear or non-linear optimization programs, including ones using the real option function. When used with an optimization program that optimizes the value of a set of asset classes, the constraint specifies a minimum reliability for the return on the asset classes with regard to the risks associated with the assets. Risks involved in the reliability restraint may include historic investment risks, political risks, or any other kind of quantifiable risk.

Other objects and advantages will be apparent to those skilled in the arts to which the invention pertains upon perusal of the following Detailed Description and drawing, wherein:

### BRIEF DESCRIPTION OF THE DRAWING

FIG. 1 is a flowchart of resource allocation according to the techniques of the invention;

FIG. 2 is a block diagram of a system for allocating investment funds which embodies the techniques of the invention;

FIG. 3 is a block diagram of an implementation of the system of FIG. 3; and

FIG. 4 is a block diagram of a computer system which may be used in the implementation of FIG. 3.

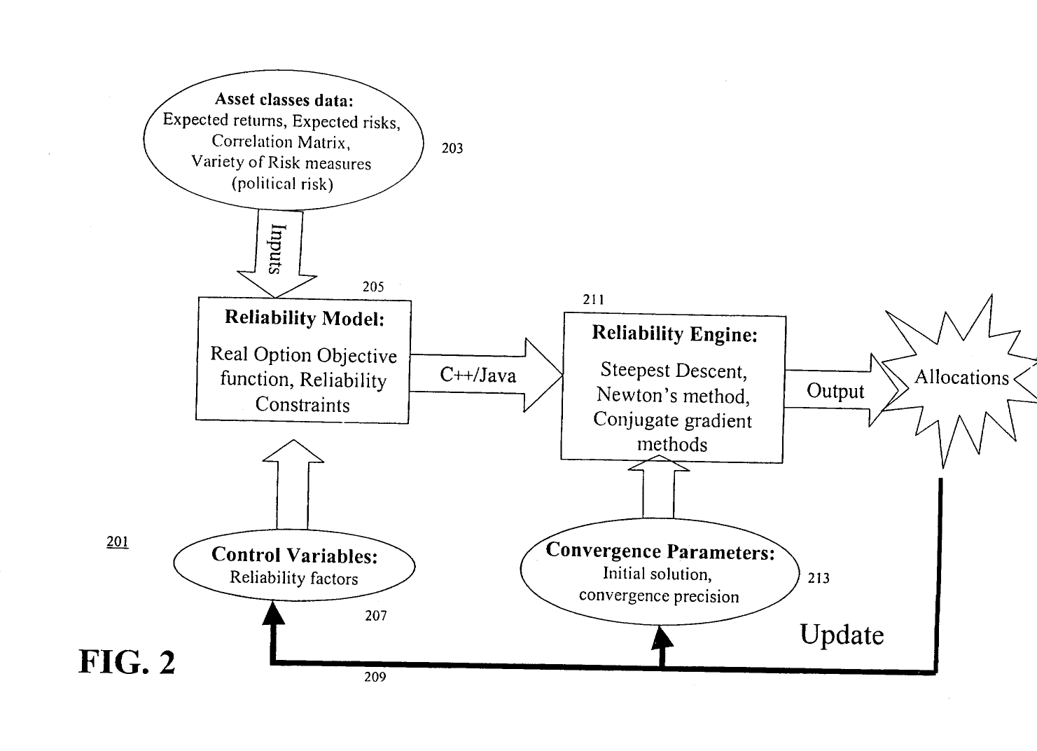

Reference numbers in the drawing have three or more digits: the two right-hand digits are reference numbers in the drawing indicated by the remaining digits. Thus, an item with the reference number 203 first appears as item 203 in FIG. 2.

### DETAILED DESCRIPTION

The following Detailed Description will begin by describing how techniques originally developed to quantify the reliability of mechanical, electrical, or electronic systems can be used to quantify the effects of diversification on risk and will then describe a resource allocation system which uses real option analysis and reliability analysis to find an allocation of the resource among a set of uses that attains a given return with a given reliability and two embodiments of such a resource allocation system.

Applying Reliability Techniques to Resource Allocation

Reliability is an important concern for the designers of mechanical, electrical, and electronic systems. Informally, a system is reliable if it is very likely that it will work correctly. Engineers have measured reliability in terms of the probability of failure; the lower the probability of failure, the more reliable the system. The probability of failure of a system is determined by analyzing the probability that components of the system will fail in such a way as to cause the system to fail. A system's reliability can be increased by providing redundant components. An example of the latter technique is the use of triple computers in the space shuttle. All of the computations are performed by each of the computers, with the computers voting to decide which result is correct. If one of the computers repeatedly provides incorrect results, it is shut down by the other two. With such an arrangement, the failure of a single computer does not disable the space shuttle, and even the failure of two computers is not fatal. The simultaneous or near simultaneous failure of all three computers is of course highly improbable, and consequently, the space shuttle's computer system is highly reliable. Part of providing redundant components is making sure that a single failure elsewhere will not cause all of the redundant components to fail simultaneously; thus, each of the three computers has an independent source of electrical power. In mathematical terms, if the possible causes of failure of the three computers are independent of each other and each of the computers has a probability of failure of ii during a period of time T, the probability that all three will fail in T is n³.

The aspect of resource allocation that performs the same function as redundancy in physical systems is diversification. Part of intelligent allocation of a resource among a number of uses is making sure that the returns for the uses are subject to different risks. To give an agricultural example, if the resource is land, the desired return is a minimum amount of corn for livestock feed, some parts of the land are bottom land that is subject to flooding in wet years, and other parts of the land are upland that is subject to drought in dry years, the wise farmer will allocate enough of both the bottom land and the upland to corn so that either by itself will yield the minimum amount of corn. In either a wet or dry year, there will be the minimum amount of corn, and in a normal year there will be a surplus.

Reliability analysis can be applied to resource allocation in a manner that is analogous to its application to physical systems. The bottom land and the upland are redundant systems in the sense that either is capable by itself of yielding the minimum amount in the wet and dry years respectively, and consequently, the reliability of receiving the minimum amount is very high. In mathematical terms, a given year cannot be both wet and dry, and consequently, there is a low correlation between the risk that the bottom land planting will fail and the risk that the upland planting will fail. As can be seen from the example, the less correlation there is between the risks of the various uses for a given return, the more reliable the return is.

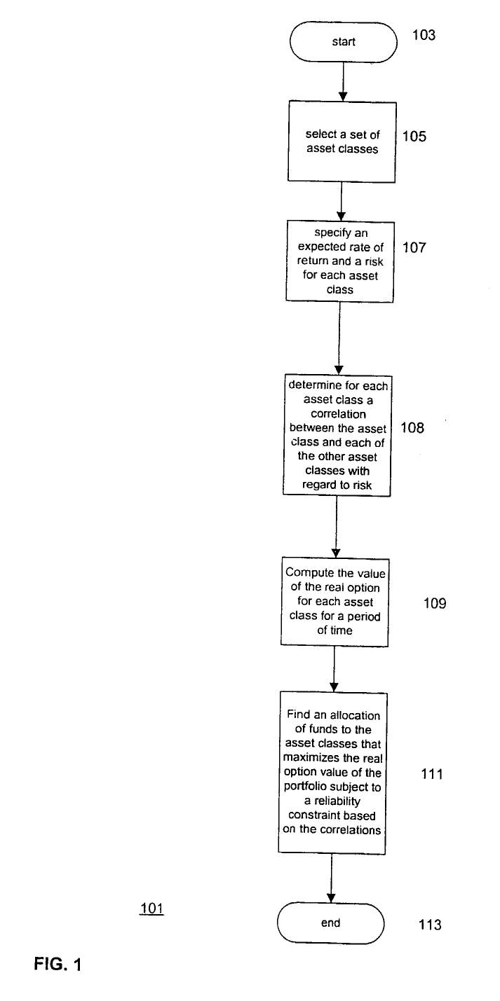

A System That Uses Real Options and Reliability to Allocate Investment Funds: FIG. 1

In the resource allocation system of the preferred embodiment, the resource is investment funds, the uses for the funds are investments in various classes of assets, potential valuations of the asset classes resulting from particular allocations of funds are calculated using real options, and the correlations between the risks of the classes of assets are used to determine the reliability of the return for a particular allocation of funds to the asset classes. FIG. 1 is a flowchart 101 of the processing done by the system of the preferred embodiment. Processing begins at 103. Next, a set of asset classes is selected (105). Then an expected rate of return and a risk is specified for each asset class (107). The source for the expected rate of return for a class and the risk may be based on historical data. In the case of the risk, the historical data may be volatility data. In other embodiments, the expected rate of return may be based on other information and the risk may be any quantifiable uncertainty or combination thereof, including economic risks generally, business risks, political risks or currency exchange rate risks.

Next, for each asset class, correlations are determined between the risk for the asset class and for every other one of the asset classes (108). The purpose of this step is to quantify the diversification of the portfolio. Thereupon, the present value of a real option for the asset class for a predetermined time is computed (109). Finally, an allocation of the funds is found which maximizes the present values of the real options (111), subject to a reliability constraint which is based on the correlations determined at 108.

Mathematical Details of the Reliability Computation

In a preferred embodiment, the reliability of a certain average return on the portfolio is found from the average rate of return of the portfolio over a period of time T and the standard deviation a for the portfolio's return over the period of time T The standard deviation for the portfolio represents the volatility of the portfolio's assets over the time T. The standard deviation for the portfolio can be found from the standard deviation of each asset over time T and the correlation coefficient p for each pair of asset classes. For each pair A,B of asset classes, the standard deviations for the members of the pair and the correlation coefficient are used to compute the covariance for the pair over the time T. with cov(A,B)_{T}=ρ_{A,B}σ_{A,T}σ_{B,T}. Continuing in more detail, for a general portfolio with a set S of at least two or more classes of assets, the portfolio standard deviation and the portfolio's rate of return can be written as:

$${σ}_{P , T}^{2} = {\sum }_{A ∈ S} {\sum }_{{B ∈ S}_{B \neq A}} {x}_{a} {x}_{b} {ρ}_{AB} {σ}_{A , T} {σ}_{B , T} + {\sum }_{A ∈ S} {x}_{A}^{2} {σ}_{A , T}^{2}$$

$${r}_{P , T} = {\sum }_{A ∈ S} {x}_{A} {r}_{A , T}$$

Where: _{σ}_{P,T} is the standard deviation (or volatility) of the portfolio over T periods of time; r_{p,t} is the average rate of return of the portfolio over T periods of time;

x_{A} is the fraction of portfolio invested in asset class A;

ρ_{A,B} is the correlation of risk for the pair of asset classes A and B;

σ_{A,T} is the standard deviation of asset class A over T periods of time;

r_{A,T} is the average rate of return of asset class A over T periods of time; and

S is the set of asset classes.

We assume in the following that the portfolio P follows a normal distribution with mean of r_{P,T} and with standard deviation of σ_{P,T}: N(r_{P,T}, U_{P,T}).

The reliability constraint α will thus be:

Pr(x≧rₘᵢₙ)≧α [symbol] 1−Φ(rₘᵢₙ−r_{P,T})/σ_{P,T}))≧α

where r_{P,T} and σ_{P,T} are replaced by their respective values from the equation above. The constraint can be estimated using the expression

$${( {r}_{min} - {\sum }_{A ∈ S} {x}_{A} {r}_{A , {T}_{A}} )}^{2} \leq {δ}^{2} {\sum }_{A ∈ S} {\sum }_{B ∈ S} {x}_{A} {x}_{B} {σ}_{AB}$$

where δ² is obtained from α using Simpson's rule. Details of the computation of ô will be provided later.

Computation of the Real Option Value of the Portfolio

The above reliability constraint is applied to allocations of resources to the portfolio which maximize the real option value of the portfolio over the time period T The real option value of portfolio is arrived at using the Black-Scholes formula. In the formula, T_{A} is the time to maturity for an asset class A and x_{Ai} is the fraction of the portfolio invested in asset class A during the period of time i, where T_{A} is divided into equal periods 0. T_{A}−1.

To price a real option for an asset class A over a time T according to the Black-Scholes formula, one needs the following values:

A, the current value of asset class A;

T, time to maturity from time period 0 to maturity;

Ex, value of the next investment;

r_{f} risk-free rate of interest;

σ, volatility

A=x_{A0}P

Ex=x_{A0}P(1+r_{min.A})^{T}^{_{A}}

For a period i, the value V_{A,i} of the real option corresponding to the choice of asset class A at time i using the Black-Scholes formula is:

$${V}_{A , i} = Φ ( \frac{log ( \frac{1}{{( 1 + {r}_{min , A} )}^{{T}_{{A}^{- i}}}} ) + ( {r}_{f} + 0.5 {σ}^{2} ) ( {T}_{A} - i )}{σ \sqrt{{T}_{A} - i}} ) {x}_{A , i} P - Φ ( \frac{log ( \frac{1}{{( 1 + {r}_{min , A} )}^{{T}_{{A}^{- i}}}} ) + ( {r}_{f} + 0.5 {σ}^{2} ) ( {T}_{A} - i )}{σ \sqrt{{T}_{A} - i}} - σ \sqrt{{T}_{A} - i} ) {x}_{A , i} {P ( 1 + {r}_{min , {T}_{A}} )}^{{T}_{{A}^{- i}}} exp ( - {r}_{f} ( {T}_{A} - i ) )$$

The above formula is an adaptation of the standard Black-Scholes formula. It differs in two respects: first, it does not assume risk-neutral valuation; second an exponential term has been added to the first term of V_{A,i} and corresponds to the discounted value for a rate of return rₐ. With these two changes, the real option value is better suited to the context of asset allocation.

The allocation of the available funds to the asset classes that maximizes the real option value of

the portfolio can be found with the optimization program

$${Max}_{{{x}_{A , i}}_{A ∈ S}} {\sum }_{A ∈ S} \frac{1}{{T}_{A} - i} ( \frac{{V}_{A , i}}{{x}_{A , i}} - {V}_{min , A} ) {x}_{A , i}$$

the program being subject to reliability constraints such as the one set forth above.

Overview of Implementation of the Investment Funds Allocation System: FIG. 2

FIG. 2 is an overview of an investment funds allocation system 201 that employs the principles of the invention. As shown at 203 and 207, there are two kinds of inputs to system 201: data 203 about the asset classes to which the investment funds are to be allocated and control variables 207. Included in the data are at least the expected risks and returns for the asset classes and a correlation matrix which correlates the expected risks and expected returns for each of the asset classes with those for each of the other asset classes. The standard deviation for each asset class and the covariance for each pair of asset classes may be computed from this data. Also included in the data may be other risk measures, such as political risk or currency exchange risk. Each risk may have its own correlation matrix or the risks may be combined in a single correlation matrix. The control variables 207 include an indication of the minimum return required and an indication of the minimum reliability required. The output of system 201, shown at 215, is an allocation of the investment funds to the asset classes. The allocation maximizes the return achieved by the funds for the specified minimum reliability.

System 201 has two major processing components: reliability model 205, which does the computation of the option values and the reliability constraint needed for the maximization, and reliability engine 211, which does the maximization using the option values and the reliability constraint. Reliability model 205 computes the reliability constraint from the correlation matrix for the asset classes. Reliability engine 213 is controlled by convergence parameters 213. One of the parameters is an initial solution for the allocation, which need not be realistic, and another is a convergence precision value, which indicates when successive improvements in the maximizations are so close in value to each other that reliability engine 211 maybe stopped.

As shown by update arrow 209, results from one maximization may be used as a starting point for the next. For example, the results of a maximization may be used as an initial solution for the next maximization. When this is done, the convergence precision value may be decreased and/or the minimum reliability may be increased and/or the rate of return increased. If a maximization does not produce a solution, the convergence precision value may be increased and/or the minimum reliability decreased and/or the rate of return decreased. In a preferred embodiment, feedback mechanism 209 utilizes standard techniques of Automatic Control Theory in order to adjust the convergence precision value and the minimum reliability.

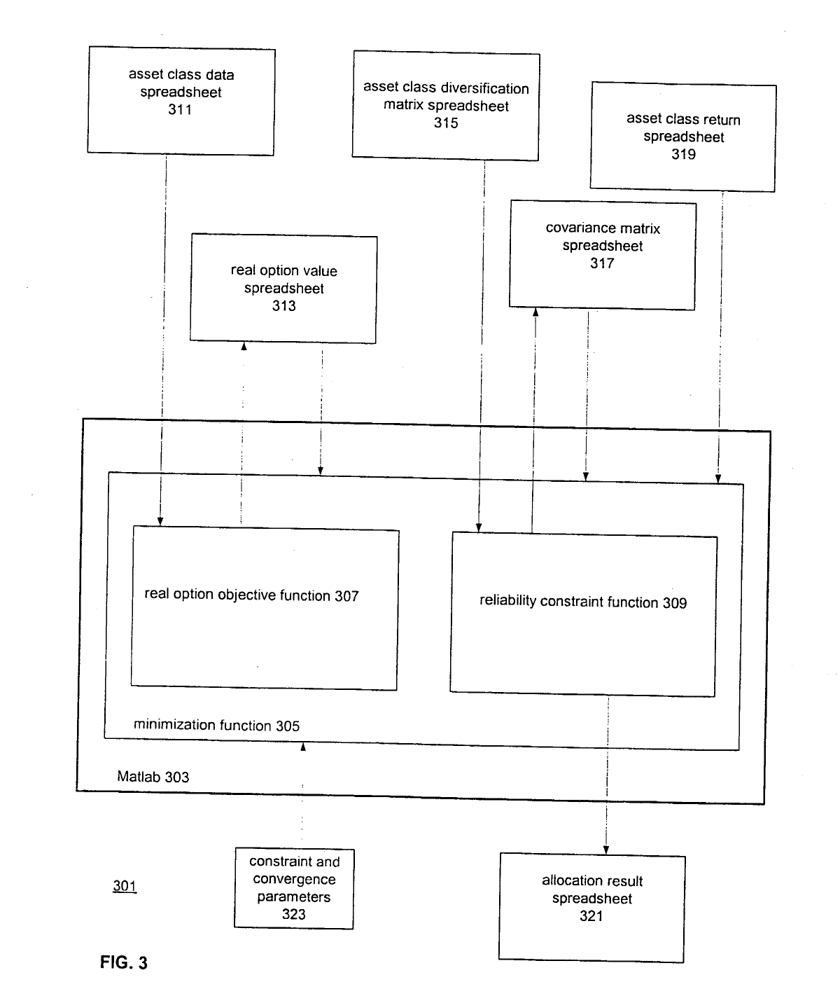

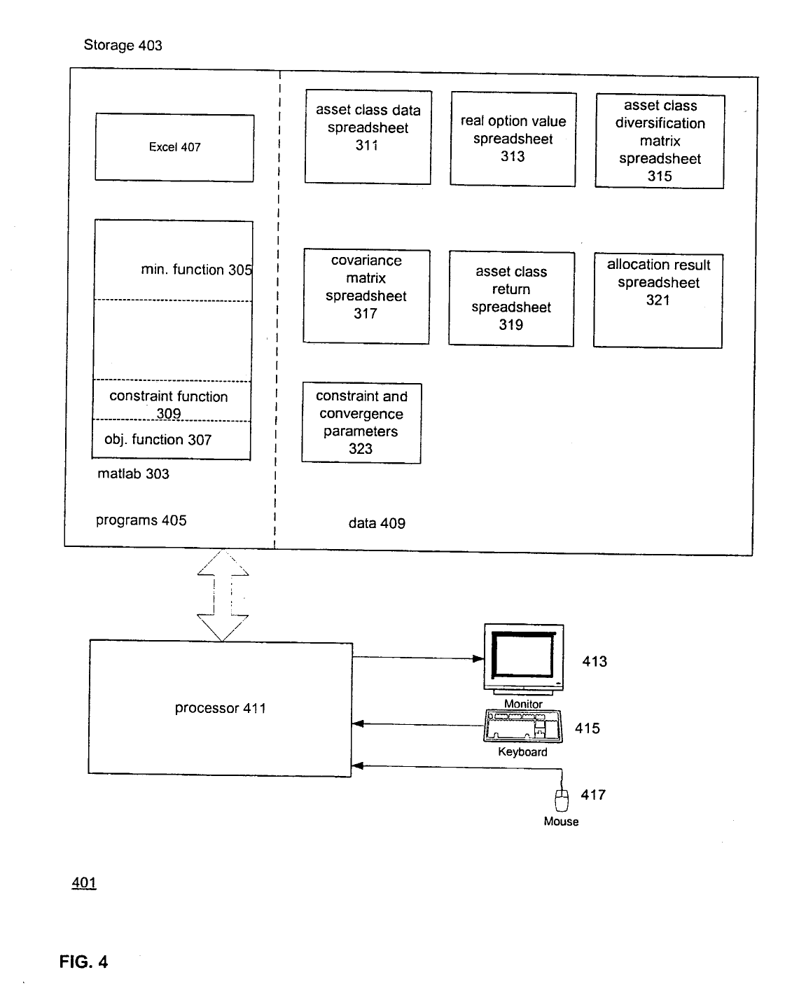

Detailed Example Implementation: FIGS. 3 and 4

FIG. 3 shows an example implementation 301 of system 201. Example implementation 301 is a prototype implementation that was made using a computer upon which the Microsoft Excel spreadsheet program manufactured by Microsoft Corporation, Redmond, Wash., and the Matlab mathematical function program manufactured by The MathWorks, Inc., Natick, Mass. can be executed. In implementation 301, the data used in the system is stored in Excel spreadsheets and the calculations are made by Matlab functions. The functions read data from and output data to the Excel spreadsheets. FIG. 3 shows the relationship of the components. The maximization is done by a Matlab minimization function 305 called fmincon (the Matlab function program includes only minimization functions). The minimization function takes as arguments an objective function and a constraint function, both user-defined, together with a starting allocation. The objective function 307 used in the implementation computes the real option value for each of the asset classes. A relevant portion of the objective function's definition in Matlab follows:

function f=objfun(x)

fid=fopen(‘v.dat’,‘r’)

V=fscanf(fid, ‘%g’, 23)

for i==1:23

y(i)=−V(i)*x(i);

end

f=sum(y)

x here represents an asset class. V is a built-in Matlab real option value function. v. dat is spreadsheet 311, which in the prototype contained data on 23 asset classes. Since fmincon is a minimization function, the function which is minimized is −V. The minimization of −V is of course equivalent to the maximization of V.

The constraint function 309 in the implementation is a function which computes the reliability constraint as described above and applies it along with four other constraints:

that there be a positive allocation of each asset class;

that the allocation of a given asset class not exceed 100% of the amount available;

that the allocations together total 100%; and

that the average return on the portfolio be greater than a specified minimum, rₘᵢₙ;

A relevant portion of the constraint function code follows:

function [c, ceq]=confuneq x);

fid=fopen(‘covar.dat’,‘r’);

A=fscanf(fid, ‘%g’, [23 23]);

fid=fopen(‘areturn.dat’,‘r’);

ra=fscanf(fid, ‘%g’, 23);

fclose(fid);

// For a better understanding, we write the values of our parameters here. In fact, these parameters are read from a file.

rmin=2.411;beta=−0.4;n=2ˆ 16;alpha=0.95; 10

simpson=1+exp(−betaˆ 2/2),

for i=1:(n/2−1)

simpson=simpson+2*exp(−(2*i*beta/n)ˆ 2/2);

end

for i=1:(n/2)

simpson=simpson+4*exp(−(2*i−1*beta/n)ˆ 2/2)

end

simpson=simpson/sqrt(2*pi);

delta=n*(alpha−0.5)/simpson;

c1=−x;

c2=x−1;

c3=−(rmin−ra‘*x’,)ˆ 2+deltaˆ 2*x*A‘*x’;

c4=rmin−ra‘*x’;

c=[c1,c2,c3,c4];

ceq=sum(x)−1;

The above fragment defines the constraint function to be the AND of the constraints named c and ceq. These are defined at the bottom of the code fragment. c is the AND of the four constraints named c1, c2, c3, and c4. c1 is the constraint that there be a positive allocation of each asset class; c2 is the constraint that no asset class receive more than 100% of the allocation; c3 is the reliability constraint; c4 is the minimum return constraint, and ceq is the constraint that all of the asset classes together use 100% of the funds to be allocated.

The fragment reads data from spreadsheet 317 and spreadsheet 319. A is thus the covariance matrix and ra the average return for each asset class. Continuing with the parameters, rmin specifies the minimum return; beta is the convergence precision value; n specifies the 40 precision to be used in the computation; alpha, finally, is the minimum reliability. The remainder of the code fragment computes the value delta, which is used to compute the reliability constraint. delta corresponds to δ in the approximation of the reliability restraint. Matlab maximization function 305 thus implements reliability engine 211, while user-defined objective function 307 and user-defined constraint function 309 implement reliability model 205.

Operation is as follows: at the beginning of operation, an asset class data spreadsheet 311 contains the data about the asset classes that is required to compute the real option value; asset class diversification matrix spreadsheet 315 contains correlations between the asset classes and the standard deviation for each asset class, and thus provides the data that is necessary to compute the covariances for the asset classes; asset class return spreadsheet 319 contains the average return for each of the asset classes. In the prototype, the reliability constraint takes only the risk embodied in the volatility of the asset classes over time into account. A constraint and convergence parameters file 323 contains parameters 213. As indicated by the arrows connecting the spreadsheets to Matlab 303, spreadsheet 311 is read by real option objective function 307, which uses the data to compute the real option value for each of the asset classes. The real option values are output to spreadsheet 313. Asset class diversification matrix spreadsheet 315 is read by reliability constraint function 309, which uses the asset class diversification matrix and the standard deviation to compute a covariance matrix for the asset classes. The covariance matrix is output to spreadsheet 317.

Maximization function 305 then uses real option value spreadsheet 313, covariance matrix spreadsheet 317, asset class return spreadsheet 319, and constraint and convergence parameters 323 as inputs in finding the allocation of the investment funds among the asset classes. The inputs from covariance matrix spreadsheet 317 and asset class return spreadsheet 319 are used by maximization function 305 to compute the reliability constraint. The allocation of the investment funds which obtains the best return subject to the reliability constraint is output to allocation result spreadsheet 321.

FIG. 4 shows a computer system 401 in which example implementation 301 may be set up and executed. System 401 has two main components, storage 403 and processor 411. Storage 403 may be any storage which is accessible from processor 411, including processor 411 's main memory, peripheral storage devices such as disk drives connected to processor 411, and storage which processor 411 may access via a network. The contents of storage 403 may be distributed in any fashion across the components of storage 403. Logically, the contents of storage 403 may be divided into programs 405, including Excel spreadsheet program 407 and

Matlab program 303, and data, which contains the data produced and used by spreadsheet program 407 and Matlab program 303.

Processor 411 may be any processor which can execute programs 407 and 303. The user interface to processor 411 is provided by monitor 413, keyboard 415, and mouse 417. Monitor 413 receives outputs from programs 303 and 407 and a user of implementation 301 provides inputs to these programs using keyboard 415 and/or mouse 417. The components of FIG. 4 may be further distributed in various fashions across a network. At one extreme, all may be part of a single processor system; at another, part of processor 411 may function functioning as a Web browser that provides output to and receives input from monitor 413, keyboard 415, and mouse 417 and all of the other components may be accessible to the browser part of processor 411 via the Internet. In such an implementation, other parts of processor 411 may be located in a Web server and the storage 403 may be located anywhere that is accessible to the server.

Another Detailed Implementation

In order to speed up the maximization process, a second implementation has been made in which reliability engine 211 is implemented using custom-written code which is executed in a supercomputer. The code employs three well-known methods in conjunction to find the maximum. The Newton method and the steepest descent method are used together; in parallel with this, the conjugate gradient method is applied; whichever technique converges more rapidly is retained. For details on the kind of non-linear optimization being employed in the second implementation, see Dimitri P. Bertsekas, Nonlinear Programming, Second Edition, Athena Scientific, 1999. Input and output are as before.

Other Reliability Constraints

The embodiment just described employs a reliability constraint that is derived from the past volatility of each asset class. However, as the fragment of the confuneq constraint function above shows, reliability constraints based on other risks may be easily added to the list. The only requirement is that the restraint be quantifiable on a per-asset class basis. Political risk provides an example here: at page 100 of the Jun. 22, 1996 Econonlist may be found national credit-risk ratings for a number of countries. Of course, the “quantification” may simply be a matter of an expert giving a value for a particular risk to each of the asset classes. Risks may also be combined within a single reliability constraint, for example, by allocating a portion of the total reliability constraint to each risk.

Other Applications of Reliability Constraints

Reliability constraints like the ones just described for the rate of return on a portfolio of investments may be used for any attribute of a set of entities whose value is aggregated from attributes of the entities which are subject to a variation which can be described in terms of a standard deviation for the individual entity and correlation matrices for combinations of the entities. The constraint may be used with any kind of computation where it makes sense, and it may be used to select among possible outputs of a computation, as in the embodiments described herein, or it may be used to select among possible inputs to a computation. An example of a general-purpose problem-solving system in which reliability constraints could be usefully employed is the one disclosed in U.S. Pat. No. 5,428,712, Elad, et al., System and method for representing and solving numeric and symbolic problems, issued Jun. 27, 1995. The combination of real options with reliability constraints can be used with many applications of real options. For applications of real options, see the Copeland and Keenan reference mentioned above.

Among the areas in which the techniques disclosed in the foregoing may be used are the following:

Allocation of funds by a money manager for a portfolio of individual securities [stocks, bonds, mutual funds, limited partnerships, etc.];

Strategic planning for a portfolio of business entities;

Evaluation by an investment banker or venture capitalist or management buyout specialist of the impact of a potential merger;

acquisition, divestiture, reorganization, buyout, etc; and

Allocation of research and development capital across a portfolio of opportunities either internal to a company or by a venture capitalist.

Conclusion

The foregoing Detailed Description has disclosed to those skilled in the relevant areas the best mode presently known to the inventors of making and using their techniques for resource allocation. As will be readily apparent to those skilled in the relevant areas, the techniques disclosed herein arc very broad and can be used not only to allocate investment funds to asset classes and to evaluate the reliability of return with regard to a given allocation, but also with regard to resource allocation in general and in any situation where the notion of reliability can reasonably be applied.

It will also be apparent to those skilled in the relevant areas that the inventions disclosed herein may be described mathematically in ways other than those found herein and that many different implementations of systems that employ the inventions are possible. Thus, for all of the foregoing reasons, the Detailed Description is to be regarded as being in all respects exemplary and not restrictive, and the breadth of the inventions disclosed herein are to be determined not from the Detailed Description, but rather from the claims as interpreted with the full breadth permitted by the patent laws.

What is claimed is:

1. A method of determining reliability with regard to a first factor which is dependent on a set of at least two second factors, each of the second factors being diversely subject to a third factor, data concerning the second factors being stored in storage accessible to a processor and the method comprising the steps performed in the processor of:
using the data to determine correlations between second factors with regard to the third factor;
using the correlations in determining a standard deviation of the third factor for the set; and
using the first factor and the standard deviation in determining a reliability with regard to the first factor.

2. The method set forth in claim 1 wherein the step of using the correlations comprises the steps of:
determining a standard deviation for each of the second factors with regard to the third factor;
using the correlations and the standard deviations for the second factors in determining covariances between the second factors with regard to the third factor; and
using the covariances in determining the standard deviation of the third factor for the set.

3. The method set forth in claim 1 wherein:
there is a plurality of the third factors.

4. The method set forth in any one of claims 1 through 3 wherein:
the set of at least two second factors is a set of uses of a resource, each use in the set having a return;
the first factor is a valuation for the entire set of uses; and
the third factor is a risk which is diverse with regard to the returns from the uses.

5. The method set forth in claim 4 wherein:
the uses in the set are classes of assets and the resource is funds for investment in the classes of assets.

6. The method set forth in any one of claims 1 through 3 wherein:
the processor performs the steps of the method as part of an optimization of the first factor; and
the reliability is used as a constraint in the optimization.

7. The method set forth in claim 6 wherein:
the set of at least two second factors is a set of uses for a resource, each use in the set having a return;
the first factor is a valuation for the entire set of uses; and
the third factor is a risk which is diverse with regard to the returns from the uses.

8. The method set forth in claim 7 wherein:
the uses are classes of assets and the resource is funds to be invested in the classes.

9. The method set forth in claim 8 wherein:
the optimization optimizes the valuation by varying the percentages of the resource used for the assets in the classes.

10. The method set forth in claim 8 wherein:
the valuation is computed using real option techniques.

11. A method of optimizing a first factor which is dependent on a set of at least two second factors, each of the second factors being diversely subject to a third factor, data concerning the second factors being stored in storage accessible to a processor and the method comprising the steps performed in the processor of:
finding a particular configuration of the set of second factors that optimizes the first factor; and
employing a constraint during the step of finding the particular configuration that specifies a reliability of the first factor with regard to the third factor which must be satisfied by the particular configuration.

12. The method set forth in claim 11 wherein:
there is a plurality of the third factors.

13. The method set forth in claim 11 further comprising the steps of:
using the data to determine correlations between the second factors with regard to the risk; and
using the correlations and the particular configuration to determine reliability of the first factor for the particular configuration.

14. The method set forth in claim 13 wherein the step of using the correlations further comprises the steps of:
using the correlations in determining a standard deviation of the third factor for the particular configuration; and
using the first factor for the particular configuration and the standard deviation therefor in determining the reliability of the first factor.

15. The method set forth in claim 14 wherein the step of using the correlations in determining a standard deviation of the third factor for the particular configuration further comprises the steps of:
determining a standard deviation for each of the second factors with regard to the third factor; and
using the correlations and the standard deviations for the second factors in determining covariances between the second factors with regard to the third factor; and
using the covariances and the particular configuration in determining the standard deviation of the particular configuration.

16. The method set forth in any one of the claims 11 through 15 wherein:
the set of at least two second factors is a set of uses of a resource, each use in the set having a return;
the first factor is a valuation for the entire set of uses; and
the third factor is a risk which is diverse with regard to the returns from the uses.

17. The method set forth in claim 16 wherein:
the uses in the set are classes of assets.

18. The method set forth in claim 16 wherein:
valuations for the set of uses are found using real option techniques.

19. A method of allocating investment funds among a set of at least two asset classes to optimize valuation of the asset classes over a period of time, data concerning the asset classes being stored in storage accessible to a processor and the method comprising the steps performed in the processor of:
employing a linear optimization program to optimize the valuation and
in the linear optimization program, using a real option function to determine valuation for each asset class over the period of time for a particular allocation of the funds to the asset class.

20. The method set forth in claim 19 wherein:
the data concerning the asset classes further indicates for each asset class a risk over the period of time and the method further comprises the step of:
employing a constraint in the linear optimization program that specifies a reliability of a return for the portfolio for a particular allocation of funds to the asset classes in the set.

21. The method set forth in claim 20 wherein:
there is a plurality of risks.

22. The method set forth in claim 20 further comprising the steps of:
using the data to determine correlations between the asset classes with regard to the risks of the asset classes; and
using the correlations and the particular allocation of funds to determine the reliability of the return for the portfolio.

23. The method set forth in claim 22 wherein the step of using the correlations further comprises the steps of:
using the correlations in determining a standard deviation of the risk for the particular configuration; and
using the return for the particular allocation of funds and the standard deviation therefor in determining the reliability of the first return.

24. The method set forth in claim 23 wherein the step of using the correlations in determining a standard deviation of the risk for the particular allocation of funds further comprises the steps of:
determining a standard deviation for each of the asset classes with regard to the risk; and
using the correlations and the standard deviations for the asset classes in determining covariances between the asset classes with regard to the risk; and
using the covariances and the particular allocation of funds in determining the standard deviation of the particular allocation of funds.
